(19) United States
(12) Patent Application Publication
(10) Pub. No.: US 2023/0394758 A1
(43) Pub. Date: Dec. 7, 2023

(54) METHOD FOR TRAINING MODEL, METHOD FOR CONTROLLING OBJECT, APPARATUS, MEDIUM, AND DEVICE

(71) Applicant: Beijing Zitiao Network Technology Co., Ltd., Beijing (CN)

(72) Inventors: Yue FU, Beijing (CN); Xuefeng HUANG, Beijing (CN); Shihong DENG, Beijing (CN)

(21) Appl. No.: 18/327,404

(22) Filed: Jun. 1, 2023

(30) Foreign Application Priority Data
Jun. 1, 2022 (CN) 202210621933.7

(51) Int. Cl. G06T 17/00; G06V 10/44; G06V 10/82

(52) U.S. Cl. CPC G06T 17/00; G06V 10/44; G06V 10/82

(57) ABSTRACT

A method for training a model, a method for controlling an object, an apparatus, a medium, and a device. The method includes acquiring an interaction sequence generated by an interaction between a first virtual object and a second virtual object in a virtual environment; acquiring a training reward weight parameter corresponding to each interaction sequence; determining a target return value corresponding to each of the sampled data, according to the training reward weight parameter corresponding to the interaction sequence and the return value in the interaction sequence; determining a target loss of the training deep reinforcement learning model, according to an action-value predicted value determined based on a state feature and a decision action of each of the sampled data and the target return value corresponding to the sampled data; and training the training deep reinforcement learning model based on the target loss.

### CROSS-REFERENCE TO RELATED APPLICATIONS

Under the applicable patent law and/or rules pursuant to the Paris Convention, this application is made to timely claim the priority to and benefits of Chinese Patent Application No. 202210621933.7, filed on Jun. 1, 2022. For all purposes under the law, the entire disclosure of the aforementioned application is incorporated by reference as part of the disclosure of this application.

### TECHNICAL FIELD

The present disclosure relates to a field of computer technologies, and more particularly, to a method for training a model, a method for controlling an object, an apparatus, a medium, and a device.

### BACKGROUND

With development of computer industries and game industries, more and more types of games have emerged. Game strategies according to existing learning paradigms cannot be effectively expanded to all game types. In related technologies, data of game users may usually be used to guide and train virtual object AI to generate strategies. However, through the above-described solutions, the strategies obtained based on learning the data game users cannot break away from a category of human users; and with respect to some games that have not been launched or have launched for a short time, due to limited data of human users, it is difficult to meet training requirements, and in some cases, it is impossible to obtain user data.

### SUMMARY

The summary part of the present disclosure is provided to briefly introduce concepts; and these concepts will be described in detail in the detailed description part later. The summary part of the present disclosure is not intended to identify key features or necessary features of the claimed technical solutions, nor is it intended to limit the scope of the claimed technical solutions.

In a first aspect, the present disclosure provides a method for training a deep reinforcement learning model, the method includes the following steps.

Acquiring an interaction sequence generated by interaction between a first virtual object and a second virtual object in a virtual environment. The interaction sequence includes multiple sampled data; each of the sampled data includes a return value obtained through the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model;

Acquiring a training reward weight parameter corresponding to each of the interaction sequences. The training reward weight parameter corresponds to a decision style type of the training deep reinforcement learning model;

Determining a target return value corresponding to each of the sampled data, according to the training reward weight parameter corresponding to the interaction sequence and the return value in the interaction sequence;

Determining a target loss of the training deep reinforcement learning model, according to an action-value predicted value determined based on a state feature and a decision action of each of the sampled data, and the target return value corresponding to the sampled data; and

Training the training deep reinforcement learning model based on the target loss.

In a second aspect, the present disclosure provides a method for controlling a virtual object, the method includes the following steps.

Determining an interactive virtual object controlled by a user that matches with a target virtual object in a target gaming. The target virtual object is controlled based on a target deep reinforcement learning model; and the target deep reinforcement learning model is obtained through training based on the training method of the deep reinforcement learning model according to the first aspect.

Determining a target reward weight parameter of the target virtual object from a variety of reward weight parameters, according to a behavior type of the target virtual object in the target gaming. The target reward weight parameter corresponds to a decision style type of the target deep reinforcement learning model.

Sampling interaction between the target virtual object and the interactive virtual object in a virtual environment, in order to obtain a target state feature.

Determining a target decision action of the target virtual object under the target state feature, based on the target state feature, the target reward weight parameter, and the target deep reinforcement learning model, to control an operation of the target virtual object based on the target decision action.

In a third aspect, the present disclosure provides an apparatus for training a deep reinforcement learning model, the apparatus includes a first acquiring module, a second acquiring module, a first determining module, a second determining module, and a training module.

The first acquiring module is configured to acquire an interaction sequence generated by interaction between a first virtual object and a second virtual object in a virtual environment. The interaction sequence includes multiple sampled data; each of the sampled data includes a return value obtained through the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model.

The second acquiring module is configured to acquire a training reward weight parameter corresponding to each of the interaction sequences, wherein, the training reward weight parameter corresponds to a decision style type of the training deep reinforcement learning model;

The first determining module is configured to determine a target return value corresponding to each of the sampled data, according to the training reward weight parameter corresponding to the interaction sequence and the return value in the interaction sequence;

The second determining module is configured to determine a target loss of the training deep reinforcement learning model, according to an action-value predicted value determined based on a state feature and a decision action of each of the sampled data, and the target return value corresponding to the sampled data.

The training module is configured to train the training deep reinforcement learning model based on the target loss.

In a fourth aspect, the present disclosure provides an apparatus for controlling a virtual object, the apparatus includes a third determining module, a fourth determining module, a sampling module, and a control module.

The third determining module is configured to determine an interactive virtual object controlled by a user that matches with a target virtual object in a target gaming. The target virtual object is controlled based on a target deep reinforcement learning model; and the target deep reinforcement learning model is obtained through training based on the training method of the deep reinforcement learning model according to the second aspect;

The fourth determining module is configured to determine a target reward weight parameter of the target virtual object from a variety of reward weight parameters, according to a behavior type of the target virtual object in the target gaming. The target reward weight parameter corresponds to a decision style type of the target deep reinforcement learning model;

The sampling module is configured to sample interaction between the target virtual object and the interactive virtual object in a virtual environment, to obtain a target state feature.

The control module is configured to determine a target decision action of the target virtual object under the target state feature, based on the target state feature, the target reward weight parameter, and the target deep reinforcement learning model, to control an operation of the target virtual object based on the target decision action.

In a fifth aspect, the present disclosure provides a computer-readable medium, having a computer program stored thereon, when executed by a processing apparatus, the program implements the steps of the method according to the first aspect or the second aspect.

In a sixth aspect, the present disclosure provides an electronic device, which includes a storage apparatus and a processing apparatus.

The storage apparatus has a computer program stored thereon.

The processing apparatus is configured to execute the computer program in the storage apparatus, to implement the steps of the method according to the first aspect or the second aspect.

In the above-described technical solutions, the interaction sequence generated by interaction between the first virtual object and the second virtual object in the virtual environment is acquired; then a target return value corresponding to each of sampled data may be determined according to the training reward weight parameter corresponding to the interaction sequence and the return value in the interaction sequence; and further, loss calculation is performed based on the target return value to train the training deep reinforcement learning model. Therefore, through the above-described technical solutions, model training may be performed respectively based on the interaction sequences generated by interaction between the current training deep reinforcement learning model and the virtual object controlled by the historical deep reinforcement learning model corresponding to the training deep reinforcement learning model, so that training may be directly performed based on the interaction data generated by the model, without operation data of a real user, to reduce dependence on data of a real user during a model training process, which may not only avoid constraints of a strategy of a real user on exploration strategy space of the model, but also may be applicable to a training scenario of a model corresponding to a game that has not been online or has been online for a short time. Moreover, with respect to each interaction sequence, there is a corresponding training reward weight parameter, and each training reward weight parameter corresponds to a decision style type of a training deep reinforcement learning model, so that during the training process of the training deep reinforcement learning model, training reward weight parameters corresponding to different interaction sequences will guide the training deep reinforcement learning model to differentiate to different decision strategy styles, to improve diversity of decision style styles in the model obtained through training, which is applicable to combat control under different styles based on a same model, without training different models with respect to different decision style styles, thereby further reducing training costs and improving training efficiency of models.

Other features and advantages of the present disclosure will be explained in detail in the subsequent detailed description part.

### BRIEF DESCRIPTION OF THE DRAWINGS

The above-described and other features, advantages and aspects of the respective embodiments of the present disclosure will become more apparent when taken in conjunction with the accompanying drawings and with reference to the detailed description below. Throughout the drawings, same or similar reference signs refer to same or similar elements. It should be understood that, the drawings are schematic and that originals and elements are not necessarily drawn to scale. In the drawings:

FIG. 1 is a flow chart of a training method of a deep reinforcement learning model provided according to an implementation of the present disclosure;

FIG. 2 is a structural schematic diagram of a training deep reinforcement learning model provided according to an implementation of the present disclosure;

FIG. 3 is a structural schematic diagram of a training deep reinforcement learning model provided according to another implementation of the present disclosure;

FIG. 4 is a flow chart of a control method of a virtual object provided according to an implementation of the present disclosure;

FIG. 5 is a block diagram of a training apparatus of a deep reinforcement learning model provided according to an implementation of the present disclosure; and

FIG. 6 shows a structural schematic diagram of an electronic device suitable for implementing an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that, the present disclosure may be embodied in various forms and should not be construed as limited to the embodiments set forth herein. Rather, these embodiments are provided for thorough and complete understanding of the present disclosure. It should be understood that, the drawings and the embodiments of the present disclosure are only for exemplary purposes, and are not intended to limit the protection scope of the present disclosure.

It should be understood that various steps described in the method implementations of the present disclosure may be executed in different orders and/or in parallel. Further, the method implementations may include additional steps and/or omit execution of the steps shown. The scope of the present disclosure will not be limited in this regard.

The term “including” and variants thereof used herein are open including, that is, “including but not limited to”. The term “based on” is “at least partially based on”. The term “one embodiment” represents “at least one embodiment”; the term “another embodiment” represents “at least one other embodiment”; and the term “some embodiments” represents “at least some embodiments”. Relevant definitions of other terms will be given in description below.

It should be noted that concepts such as “first”, “second”, etc. as mentioned in the present disclosure are only used to distinguish apparatuses, modules or units, but not to define orders or interdependence of functions executed by these apparatuses, modules or units.

It should be noted that modification of “one” and “a plurality of” as mentioned in the present disclosure is exemplary rather than restrictive, and those skilled in the art should understand that unless otherwise explicitly specified in the context, it should be understood as “one or more”.

Names of messages or information interacted between a plurality of apparatuses according to the implementations of the present disclosure are only used for illustrative purposes, and are not used to limit the scope of these messages or information.

All actions to acquire signals, information, or data according the present disclosure are carried out in compliance with corresponding data protection regulations and policies of the country where they are located, and authorized by a corresponding apparatus owner.

It may be understood that before using the technical solutions disclosed in in the respective embodiments of the present disclosure, a user should be informed of type, usage scope, usage scenarios, etc. of personal information involved in the present disclosure and authorization from the user should be acquired according to relevant laws and regulations in an appropriate manner.

For example, in response to receiving an active request of a user, a prompt message is sent to the user to clearly remind the user that the operation to be executed as requested by the user will require acquiring and using personal information of the user. Thus, according to the prompt information, the user may autonomously choose whether to provide personal information to software or hardware such as an electronic device, an application, a server, or a storage medium that executes the operation of the technical solution of the present disclosure.

As an optional but non-restrictive implementation, in response to receiving an active request of a user, a prompt message may be sent to the user through a pop-up window, where a prompt message may be presented in text. In addition, the pop-up window may also carry a selection control for the user to choose whether to “agree” or “disagree” to provide personal information to an electronic device.

It may be understood that the above-described processes of informing and acquiring user authorization are only illustrative and do not constitute a limitation on the implementation of the present disclosure; other modes that meet relevant laws and regulations may also be applied to the implementation of the present disclosure.

Meanwhile, it may be understood that the data involved in the technical solution (including but not limited to the data per se, acquisition or use of data) should comply with requirements of corresponding laws, regulations and relevant stipulations.

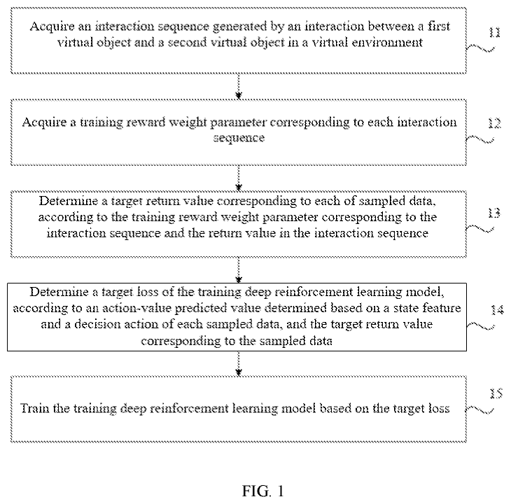

FIG. 1 is a flow chart of a method for training a deep reinforcement learning model provided according to an implementation of the present disclosure; and as illustrated in FIG. 1, the method includes:

Step 11: acquiring an interaction sequence generated by an interaction between a first virtual object and a second virtual object in a virtual environment. The interaction sequence includes multiple sampled data; each of the sampled data includes a return value obtained by the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model.

The deep reinforcement learning model combines perception capability of deep learning with decision-making capability of reinforcement learning, acquires high-dimensional observation through interaction between an agent and an environment at each sampling moment, and perceives the observation by using a deep learning method, so as to obtain a specific state feature representation of the observation; then the deep reinforcement learning model may determine a decision action under the state feature based on a reinforcement learning method; for example, may evaluate a value function (a state value functions) of respective states and a value function (an action value function) of a state-action pair based on an expected return, and improve a decision strategy based on the two value functions; wherein, the decision strategy is used for mapping a current state to a corresponding decision action. Further, the environment will react to the decision action and a next observation will be obtained until a final state, so as to complete one round.

For example, the virtual environment may be a computer-generated virtual scenario environment, for example, the virtual environment may be a game scenario. Exemplarily, by rendering multimedia data used for interaction with a user, the multimedia data may be rendered and displayed as a game scenario; the virtual environment provides a virtual world of multimedia, where the user may control a virtual object AI action through a control on an operation interface, or directly control an operable virtual object in the virtual environment, observe substances, characters, and landscapes, etc. in the virtual environment from a perspective of the virtual object, and interact with other virtual objects in the virtual environment through the virtual object. The virtual object may be a virtual image for simulating the user in the virtual environment, which may be a human image or other animal image, etc.

In this embodiment, the first virtual object and the second virtual object may be located in the virtual environment and controlled by different deep reinforcement learning models. Exemplarily, in a one-on-one virtual game environment, a first virtual object O1 and a second virtual object O2 may be included; an attack output by O1 may cause damage to O2, thus O1 wins a reward; O1 may also evade an attack output by O2 to avoid damage caused by an attack output by O2 to O1. Similarly, an operation of O2 is similar to the operation of O1, through interaction between the two until an end of the round.

For example, the historical deep reinforcement learning model may be any model obtained during a training process of the training deep reinforcement learning model. In order to further ensure training efficiency and accuracy of the model, one of models corresponding to latest updates may be selected as the historical deep reinforcement learning model; for example, the latest historical model corresponding to the training deep reinforcement learning model may be selected as the historical deep reinforcement learning model, that is, the training deep reinforcement learning model is directly obtained after updating a parameter of the historical deep reinforcement learning model. Therefore, similarity between the historical deep reinforcement learning model and the training deep reinforcement learning model may be ensured to some extent, to increase gaming difficulty during interaction between the first virtual object and the second virtual object, so as to improve effectiveness of the interaction sequence.

Step 12: acquiring a training reward weight parameter corresponding to each interaction sequence. The training reward weight parameter corresponds to a decision style type of the training deep reinforcement learning model.

In the training process of the deep reinforcement learning model, usually a corresponding reward function needs to be set, to evaluate a value of a certain action executed by an intelligent agent in a current state, which is usually calculated based on the reward function. The reward function may include a plurality of reward items; it is illustrated by taking the virtual object as a combat game AI; the reward items may include reward obtained when the first virtual object finally wins, punishment for damage suffered by the first virtual object at the current moment, reward for damage caused by the first virtual object to the enemy at the current moment, and reward for remaining friendship skills of the first virtual object at the gaming end, etc.; and the reward items and the reward function may be set according to specific application scenarios, which will not be limited in the present disclosure.

In the embodiment of the present disclosure, there may be a variety of reward weight parameters; the training reward weight parameter is one of the variety of reward weight parameters; each reward weight parameter includes a weight corresponding to each reward item in the reward function, so that a decision style may be differentiated by adjusting the weight of the reward item; when sampling the interaction sequence, a corresponding reward weight parameter will be preset, then the corresponding reward weight parameter when generating the interaction sequence may be taken as the training reward weight parameter corresponding to the interaction sequence.

Step 13: determining a target return value corresponding to each of sampled data, according to the training reward weight parameter corresponding to the interaction sequence and the return value in the interaction sequence;

Exemplarily, the target return value may be a value obtained by weighting each reward item based on the training reward weight parameter. Exemplarily, a value of each reward item in the reward function may be determined based on the return value in the interaction sequence. For example, with respect to a reward item that exists in the return value corresponding to the sampled data, if the return value includes a reward return for causing damage to the enemy at the current moment, then the value of the corresponding reward item is just the reward return; with respect to a reward item that does not exist in the return value corresponding to the sampled data, for example, reward obtained at final win, which will only appear in the sampled data at the round end, if the return value corresponding to the sampled data does not include the reward item, the value of the reward item may be determined to be 0.

Based on the examples as described above, the reward function with respect to a combat game may be expressed below:

r=w₁·r_{win}+w₂·r_{my_hp}+w₃·r_{you_hp}+w₄·r_{fs}+

Where, r_{win} is used to represent the reward at final win; r_{my_hp} is used to represent the punishment for damage suffered at the current moment, r_{you_hp} is used to represent the reward for causing damage to the enemy at the current moment, r_{fs} is used to represent the reward for remaining friendly skills at the gaming end; w₁, w₂, w₃, and w₄ each represent a weight corresponding to each reward item, that is, the variety of weight values form a group of reward weight parameters. Where, types and quantities of reward items may be set according to actual application scenarios, and the above are only illustrative and not limitative.

Step 14: determining a target loss of the training deep reinforcement learning model, according to an action-value predicted value determined based on a state feature and a decision action of each sampled data, and the target return value corresponding to the sampled data.

For example, the deep reinforcement learning model may include a strategy network and a value network, which may be implemented through a neural network structure. The strategy network is used for generating a decision action according to the current state feature and the value determined by the value network; the value network is used for estimating reward of an action under the current state feature, that is, the state feature and the action are input into the value network to obtain a state-action value, that is, the action-value predicted value. Wherein, the action-value predicted value is used to represent a predicted return value of executing the action under the current state feature, while the target return value may be used to represent a return value that may be acquired by executing the action under the state feature determined in actual data, so that error calculation may be performed based on the above two; for example, a mean square error corresponding to the action-value predicted value and the target return value may be taken as the target loss of the training deep reinforcement learning model.

Step 15: training the training deep reinforcement learning model based on the target loss.

The parameter of the training deep reinforcement learning model may be updated based on the target loss in a case where the number of trainings of the training deep reinforcement learning model does not reach a target number. As described above, the deep reinforcement learning model may include a strategy network and a value network; then in this embodiment, gradient information corresponding to the strategy network and the value network may be respectively determined based on the target loss, so that the respective parameters in the training deep reinforcement learning model may be updated based on the gradient information, to ensure accuracy of a parameter update gradient direction and improve training and updating efficiency of the model. Wherein, a gradient update mode commonly used in the art may be adopted for updating, which will not be limited in the present disclosure.

In the above-described technical solutions, the interaction sequence generated by interaction between the first virtual object and the second virtual object in the virtual environment is acquired; then a target return value corresponding to each of sampled data may be determined according to the training reward weight parameter corresponding to the interaction sequence and the return value in the interaction sequence; and further, loss calculation is performed based on the target return value to train the training deep reinforcement learning model. Therefore, through the above-described technical solutions, model training may be performed respectively based on the interaction sequences generated by interaction between the current training deep reinforcement learning model and the virtual object controlled by the historical deep reinforcement learning model corresponding to the training deep reinforcement learning model, so that training may be directly performed based on the interaction data generated by the model, without operation data of a real user, to reduce dependence on data of a real user during a model training process, which may not only avoid constraints of a strategy of a real user on exploration strategy space of the model, but also may be applicable to a training scenario of a model corresponding to a game that has not been online or has been online for a short time. Moreover, with respect to each interaction sequence, there is a corresponding training reward weight parameter, and each training reward weight parameter corresponds to a decision style type of a training deep reinforcement learning model, so that during the training process of the training deep reinforcement learning model, training reward weight parameters corresponding to different interaction sequences will guide the training deep reinforcement learning model to differentiate to different decision strategy styles, to improve diversity of decision style styles in the model obtained through training, which is applicable to combat control under different styles based on a same model, without training different models with respect to different decision style styles, thereby further reducing training costs and improving training efficiency of models.

In one possible embodiment, an output layer of the training deep reinforcement learning model includes a plurality of output forks; and the output forks are in one-to-one correspondence with the preset variety of reward weight parameters;

Correspondingly, an exemplary implementation of training the training deep reinforcement learning model based on the target loss may include:

Updating a parameter corresponding to the output fork corresponding to the training reward weight parameter in the training deep reinforcement learning model based on the target loss, the training reward weight parameter being one of the variety of reward weight parameters.

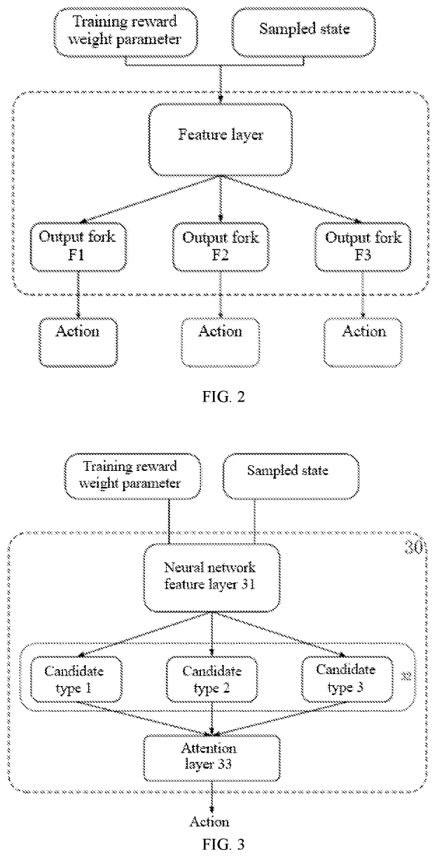

In this embodiment, different interaction sequences may be generated through decision interaction based on different reward weight parameters; and therefore, in order to further improve effective differentiation of reward items in the reward function during an initial stage of model training, the training reward weight parameter is taken as an input of the model according to the embodiment of the present disclosure. As shown in FIG. 2, the output layer of the training deep reinforcement learning model may be set as a plurality of output forks, that is, a multi-head neural network; and each output fork is in one-to-one correspondence with the training reward weight parameter, that is, the training deep reinforcement learning model will output a plurality of results, and each result corresponds to an action output of a decision style type.

Based on this, after the target loss is determined in this embodiment, the parameter corresponding to the output fork corresponding to the training reward weight parameter may be updated based on the target loss, wherein, the mode of updating the parameter is similar to that as described above, and no details will be repeated here.

Therefore, through the above-described technical solutions, a corresponding output fork may be set with respect to each training reward weight parameter, that is, with respect to each decision style, to facilitate obtaining an output action under the decision style corresponding to the training reward weight parameter. Meanwhile, during the training process of the training deep reinforcement learning model, targeted updates may be made to the parameter of the output fork corresponding to the reward weight parameter in the training deep reinforcement learning model based on an interaction sequence generated under a same reward weight parameter, to ensure accuracy of parameter update under each decision style type; guiding the training deep reinforcement learning model to differentiate to different decision strategies through the training reward weight parameter corresponding to the interaction sequence may avoid influence between training data under different decision style types and ensure accuracy of model update.

In one possible embodiment, the interaction sequence may be generated in a mode below:

Determining the training reward weight parameter of the training deep reinforcement learning model.

A variety of reward weight parameters may be preset according to human experience; following the example as described above, if the reward function includes the 4 reward items as described above, then the reward weight parameters may be set as follows:

With respect to an offensive type: if the AI receives no punishment after suffering damage from the enemy, which encourages the AI to cause as much damage as possible as compared with the enemy while ensuring victory, then the reward weight parameters are set as follows:
w₁=1, w₂=0, w₃=1, w₄=1

With respect to a defensive type: if the AI receives no reward after causing damage to the enemy, which encourages the AI to avoid the enemy's attack as much as possible and not to initiate an attack, then the reward weight parameters are set as follows:
w₁=1, w₂=1, w₃=0, w₄=1

With respect to a balance type: if the AI receives punishment after suffering damage from the enemy, and at a same time receives reward after causing damage to the enemy, which encourages the AI to avoid enemy's attack while causing more damage, then the reward weight parameters are set as follows:
w₁=1, w₂=1, w₃=1, w₄=1

Therefore, before generating the interaction sequence, the training reward parameters of the training deep reinforcement learning model may be randomly selected, that is, any one of the three types shown above may be selected, to determine the decision style type corresponding to the training deep reinforcement learning model in the interaction round. For example, if the determined training reward weight parameters are w₁=1, w₂=0, w₃=1, w₄=1, it indicates that in the interaction round, the training deep reinforcement learning model aims to cause as much damage as possible as compared with the enemy while ensuring victory, when determining the decision action and the return.

Thereafter, the interaction between the first virtual object and the second virtual object in the virtual environment is sampled, in order to obtain the state feature corresponding to the first virtual object.

The sampling may be performed in the virtual environment based on a game simulator at preset time intervals, to obtain the corresponding state feature of the first virtual object. Exemplary, the state feature may include: position, posture, health point, etc. of the first virtual object, position, posture, health point, etc. of the second virtual object, as well as reward information and punishment information in the environmental state. It should be noted that feature information specifically contained in the state feature may be set according to actual application scenarios, which will not be limited in the present disclosure.

Thereafter, a decision action of the first virtual object under the state feature is determined based on the state feature, the training reward weight parameter, and the training deep reinforcement learning model, to control the operation of the first virtual object based on the decision action, and return to the step of sampling interaction between the first virtual object and the second virtual object in the virtual environment, to obtain the corresponding state feature of the first virtual object, until the end of the interaction round.

The state feature and the training reward weight parameter may be input into the training deep reinforcement learning model, so that the training deep reinforcement learning model outputs the decision action, to further control the operation of the first virtual object. Thereafter, the above-described step may be repeated for further sampling, and the decision action may be further generated based on the sampled state feature to control the first virtual object step by step, until the end of the interaction round, that is, the first virtual object and the second virtual object obtain a combat result.

The sampled data acquired by sampling from the interaction round is sorted in an order of sampling time, to obtain the interaction sequence; and the interaction sequence is associated with the training reward weight parameter. Each of the sampled data includes the return value obtained by executing the decision action under the state feature in the virtual environment.

Thereafter, the respective sampled data obtained by sampling in the interaction round may be sequentially arranged to form an interaction sequence, and the interaction sequence is associated with a training reward weight parameter corresponding thereto, so that in the subsequent process of training the training deep reinforcement learning model based on the interaction sequence, the training reward weight parameter corresponding to the interaction sequence may be directly determined after the interaction sequence is obtained, to further ensure accuracy of the training process of the training deep reinforcement learning model, to facilitate constraining decision style differentiation of the training deep reinforcement learning model based on the training reward weight parameter, and to ensure update accuracy of the training deep reinforcement learning model.

In one possible embodiment, the output layer of the training deep reinforcement learning model includes a plurality of output forks; and the output forks are in one-to-one correspondence with the preset variety of reward weight parameters;

Correspondingly, the exemplary implementation of determining a decision action of the first virtual object under the state feature, based on the state feature, the training reward weight parameter, and the training deep reinforcement learning model, may include:

Inputting the state feature and the training reward weight parameter into the training deep reinforcement learning model, to perform feature extraction on the state feature and the training reward weight parameter through a feature layer of the training deep reinforcement learning model, obtaining sub-outputs corresponding to the plurality of output forks of the output layer based on the extracted feature, and determining the decision action, according to the sub-output corresponding to the output fork corresponding to the training reward weight parameter in the training deep reinforcement learning model.

For example, as illustrated in FIG. 2, the feature layer of the training deep reinforcement learning model may be implemented through a neural network; then, the state feature and the training reward weight parameter may be input into the training deep reinforcement learning model, so as to perform feature extraction on the state feature and the training reward weight parameter and encode the same; subsequent processing is performed based on the extracted feature, for example, the action value and the state value under the current state feature may be estimated based on the extracted feature, and a sub-output corresponding to each output fork of the output layer is further determined based on the action value and the state value as well as the decision strategy. As illustrated in FIG. 2, an output fork F1 corresponds to the reward weight parameter of the offensive type, an output fork F2 corresponds to the reward weight parameter of the defensive type, and an output fork F3 corresponds to the reward weight parameter of the balance type; and therefore, 3 actions may be respectively output in the above-described modes. Exemplarily, the sub-output corresponding to the output fork F1 is used to represent an action to be executed when it is in the state feature under the offensive decision style type corresponding thereto.

Further, the decision action may be determined according to the sub-output corresponding to the output fork corresponding to the training reward weight parameter. For example, if the training reward weight parameter corresponding to the interaction round is initially determined as the reward weight parameter corresponding to the offensive type, the action corresponding to the sub-output corresponding to the output fork F1 may be determined as the decision action.

Therefore, through the above-described technical solutions, different output forks are formed with respect to each reward weight parameter in the output layer of the training deep reinforcement learning model, so that corresponding actions under different decision style types may be respectively output; further, a final decision action is determined in combination with the decision style type corresponding to the interaction round, to ensure accuracy of determining the decision action; and meanwhile, by taking the obtained interaction sequence corresponding to the decision style type as training data, accurate and reliable data support is provided for strategy style differentiation of the training deep reinforcement learning model.

In practical application scenarios, in order to obtain decision strategy styles as diverse as possible, usually a large number of combinations of reward weight parameters will be obtained based on some prior knowledge of human users. However, with the increasing number of decision style types, higher requirements are placed on training of a network with a plurality of output forks. Based on this, the present disclosure further provides implementations below.

In one possible embodiment, another exemplary implementation of determining a decision action of the first virtual object under the state feature, based on the state feature, the training reward weight parameter, and the training deep reinforcement learning model, may include:

Inputting the state feature and the training reward weight parameter into the training deep reinforcement learning model, and determining the decision action according to the output of the training deep reinforcement learning model;

The training deep reinforcement learning model 30 includes a neural network feature layer 31, a type feature layer 32, and an attention layer 33, as illustrated in FIG. 3.

The neural network feature layer is used for determining a state feature vector corresponding to the state feature and a parameter feature vector corresponding to the training reward weight parameter; the type feature layer is used for determining a type feature vector corresponding to each candidate type under the type feature layer based on the state feature vector and the parameter feature vector. The candidate type is in one-to-one correspondence with a hidden-layer decision style; the attention layer is used for fusing a type feature vector corresponding to each type based on an attention mechanism according to the parameter feature vector, and determining the output of the training deep reinforcement learning model according to a fusion result.

The type feature layer may include a plurality of candidate types; the candidate type is in one-to-one correspondence with the hidden-layer decision style, that is, each candidate type corresponds to an implicit representation of the decision style; then the type feature vector under the hidden-layer decision style corresponding thereto may be determined through the type feature layer; and the type feature vector just represents an action feature under the hidden-layer decision style. Thereafter, the plurality of action features are fused through the attention layer, in order to represent more decision style types based on the plurality of hidden-layer decision styles.

Based on the attention mechanism, attention may be focused on important information while extraction of some irrelevant information is suppressed. In deep learning, the attention mechanism may be described as mapping of a query vector and a key-value pair to attention weights. Exemplarily, in this embodiment, each type feature vector may be taken as a key vector and a value vector in the key-value pair; and the training reward weight parameter is taken as a query vector for attention processing. Specifically, an inner product operation may be performed on the query vector and the key vector in the key-value pair, to obtain similarity between the query vector and the key vector; after the inner product operation, a scaling operation and a normalization index operation, such as a softmax function operation, are sequentially performed, to obtain the attention weight between the query vector and the key vector; finally, an inner product operation is further performed on the value vector in the key-value pair through the attention weight, to obtain a final attention calculation result, that is, the attention weight is determined based on the training reward weight parameter and the respective type feature vectors, and weighted summation is performed on the respective type feature vectors based on the attention weight, so as to fuse the type feature vectors, and obtain a fusion result, that is, a fusion feature vector obtained after weighted summation.

Therefore, through the above-described technical solutions, the type feature layer may be set in the training deep reinforcement learning model, and the plurality of hidden-layer decision styles may be taken as implicit features in the model; fusing the implicit features to represent more types of decision style features may avoid impact of the plurality of output forks on efficiency of training the training deep reinforcement learning models including a variety of decision style types, reduce difficulties in model training and learning, and at a same time, also facilitate expansion of decision style types.

In one possible embodiment, the first virtual object and the second virtual object have different role types; and the historical deep reinforcement learning model and the training deep reinforcement learning model respectively correspond to different training reward weight parameters. For example, when a virtual object is gaming, it may correspond to a plurality of optional role types; for example, in a game scenario, each hero that the user may select may be a role type.

Correspondingly, the role type corresponding to the second virtual object and the training reward weight parameter corresponding to the historical deep reinforcement learning model are determined in a mode below:

Acquiring a training role type corresponding to the first virtual object controlled by the training deep reinforcement learning model. Wherein, the training role type may be directly acquired after the role of the first virtual object is selected, or the role corresponding to the first virtual object may also be specified by the staff according to a training process or randomly selected, which will not be limited in the present disclosure.

Thereafter, determining a first target winning probability between a virtual object corresponding to the training role type and a virtual object corresponding to each candidate role type among the preset plurality of role types except the training role type;

Determining a second target winning probability between a virtual object controlled based on a deep reinforcement learning model corresponding to a first reward weight parameter and a virtual object controlled based on a deep reinforcement learning model corresponding to a second reward weight parameter, wherein, the first reward weight parameter is the training reward weight parameter corresponding to the training deep reinforcement learning model, and the second reward weight parameter is each reward weight parameter among the preset variety of reward weight parameters except the first reward weight parameter.

For example, during the training process, the role types and the reward weight parameters respectively corresponding to both sides of gaming may be recorded; then, winning and losing results corresponding to the interaction sequences generated in the respective interaction rounds during the training process may be counted, so that the corresponding winning probabilities of the respective role types under the respective decision style types may be obtained. Exemplarily, with respect to an interaction sequence where two sides in the combat are an offensive role X and a defensive role Y, and then a winning probability of the two sides in the combat may be determined based o combat results of the respective interaction sequences that are the same for both sides. Exemplarily, a winning probability corresponding to each role type under each decision style type may be stored based on a two-dimensional matrix.

As an example, if the determined training role type is U1, then with respect to the training role type U1 and a candidate role type Ux, an average value of winning probabilities of a virtual object under U1 under the respective reward weight parameters and a virtual object under Ux under the respective reward weight parameters may be taken as the first target winning probability of the combat of the virtual objects under U1 and Ux, that is, a probability of the virtual object under U1 beating the virtual object under Ux. The first target winning probability between the training role type U1 and other candidate role type may be determined in the same way.

Similarly, with respect the first reward weight parameter G1 and the second reward weight parameter Gx, an average value of winning probabilities of a virtual object corresponding to respective role types under the first reward weight parameter G1 and a virtual object corresponding to respective role types under the second reward weight parameter Gx may be taken as a second target winning probability of the combat between the virtual objects controlled by the deep reinforcement learning models corresponding to G1 and Gx, that is, a probability of the virtual object controlled by the deep reinforcement learning model corresponding to G1 beating the virtual object controlled by the deep reinforcement learning model corresponding to Gx.

Further, the role type corresponding to the second virtual object is determined from the candidate role types, based on the training role type and the first target winning probability; and the training reward weight parameter corresponding to the historical deep reinforcement learning model is determined from the second reward weight parameter, based on the training reward weight parameter corresponding to the training deep reinforcement model and the second target winning probability.

As an example, the role type corresponding to the second virtual object may be determined from the role types with the first target winning probability greater than the first winning probability threshold; for example, one may be randomly selected from the role types with the first target winning probability greater than the first winning probability threshold, or a role type corresponding to the first target winning probability closest to the first winning probability threshold may also be selected as the role type corresponding to the second virtual object. Similarly, the training reward weight parameter corresponding to the historical deep reinforcement learning model may be determined from the reward weight parameter with the second target winning probability greater than the second winning probability threshold, one may be randomly selected from the reward weight parameter with the second target winning probability greater than the second winning probability threshold, or the reward weight parameter corresponding to the second target winning probability closest to the second winning probability threshold may also be selected as the training reward weight parameter corresponding to the historical deep reinforcement learning model. Exemplarily, the first winning probability threshold and the second winning probability threshold may be the same or different; exemplarily, the first winning probability threshold and the second winning probability threshold may both be set to 0.5, to ensure both sides in the combat to have similar winning probabilities, and improve learning efficiency of the model.

As another example, sampling may be performed based on a mode of Prioritized Fictitious self-play (PFSP). Taking selection of role types as an example, with respect to a training role type a, a candidate set C of role types corresponding thereto may include any role type among the plurality of role types except a; and then a probability p_{b} of selecting one role type b in the candidate set C may be determined in a mode below:

That is,

$${p}_{b} = \frac{f ( P [ a beats b ] )}{Z \text{?} f ( P [ a beats \text{?} ] )}$$

$$\text{?} \text{indicates text missing or illegible when filed}$$

Where, P[a beats b] is used to represent a probability that the role type a defeats the role type b, that is, the first target probability between the role type a and the role type b as described above; ƒ(x) may adopt a linear function such as ƒ(x)−1−x, or may also adopt a commonly used function of PFSP in the art, which will not be limited. A denominator in the above-described formula is a sum of the winning probabilities of the role type a beating all role types in the candidate set; then from the above-described formula, it may be seen that the lower the winning probability of the role type a beating the role type b, the greater the probability of the role type b being selected, so sampling may be performed in the candidate set according to the probability corresponding to the role type, to obtain the role type corresponding to the historical deep reinforcement learning model.

Similarly, the training reward weight parameter corresponding to the historical deep reinforcement learning model may also be sampled in a way similar to the PFSP as described above, and no details will be repeated here.

Therefore, through the above-described technical solutions, after the training role type and the training reward weight parameter corresponding to the training deep reinforcement learning model are determined, the training role type and the training reward weight parameter corresponding to the historical deep reinforcement learning model may be further determined based on the training role type and the training reward weight parameter, to ensure a difficulty degree of interaction between the first virtual object and the second virtual object, so as to improve strategy optimization efficiency of the training deep reinforcement learning model based on the interaction sequence, and improve training efficiency of the training deep reinforcement learning model.

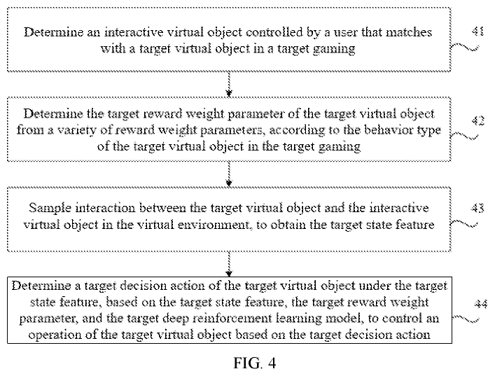

FIG. 4 is a flow chart of a method for controlling a virtual object provided according to an implementation of the present disclosure; and the method may include:

Step 41: determining an interactive virtual object controlled by a user that matches with a target virtual object in a target gaming. The target virtual object may be controlled based on a target deep reinforcement learning model; and the target deep reinforcement learning model may be obtained through training based on the training method of the deep reinforcement learning model according to any one of the above;

The method may be applied to one-on-one game scenarios, for example, a 1v1 wrestle game environment, where the target virtual object is controlled based on a target deep reinforcement learning model, and the interactive virtual object is a game AI controlled by user operations; in a human-machine interaction gaming, the virtual object controlled by the target deep reinforcement learning model may be matched with the virtual object controlled by the user; thereafter, a game result may be obtained through interaction between both sides; correspondingly, after gaming match is generated, the virtual object controlled by the user may be taken as the interactive virtual object. In step 42, the target reward weight parameter of the target virtual object is determined from a variety of reward weight parameters, according to the behavior type of the target virtual object in the target gaming, wherein, the target reward weight parameter corresponds to a decision style type of the target deep reinforcement learning model.

There may be a variety of decision style types of the target deep reinforcement learning model; and each decision style type corresponds to a decision strategy. For example, in combat games, the decision style types may include an offensive type, a defensive type, and a balance type; as described above, the decision strategy of the offensive type is more focused on actively launching an attack, the decision strategy of defensive type is more focused on defending rather than attacking, and the decision strategy of the balance type is equally focused on attacking and defending to make a balanced decision according to a current situation.

As an example, the user may select a type of combat he/she wants during the combat; for example, the user may select an AI style he/she needs through a selection control in a game interface, so that he/she may take the AI style as the behavior type of the target virtual object. The behavior type is used to represent the decision style type of the target virtual object, and a corresponding relationship between the behavior type and the reward weight parameter may be preset, so that the target reward weight parameter of the target virtual object may be determined based on the corresponding relationship, after the behavior type of the target virtual object is determined.

For example, the behavior type of the target virtual object in the target gaming is determined in a mode below:

Determining the behavior type of the target virtual object at the beginning of the target gaming, based on the historical gaming data of the interactive virtual object.

As another example, the historical gaming data of the interactive virtual object corresponding to the user may be acquired with user authorization; further, parameters such as attack frequency and defense frequency output by the user during the historical game process may be determined, so that operation parameters of the user may be determined based on the attack frequency and the defense frequency, and further the behavior type of the target virtual object is determined based on the operation parameters. If a table of corresponding relationship between the operation parameters and the behavior types may be preset, the behavior type of the target virtual object may be determined during the application process directly based on the obtained operation parameters of the user and the table of corresponding relationship.

As another example, in the process of target gaming, if a type update condition is met, the behavior type of the target virtual object is determined based on the gaming data of the interactive virtual object in the target gaming.

The update condition may be that the target gaming has reached an update moment; for example, one update moment may be set at every preset time interval after start of the target gaming until the end of the target gaming, for example, one update moment may be determined every 5 minutes after start of the target gaming, to determine the behavior type of the target virtual object based on the current gaming data in the target gaming. For another example, the update condition may be that cumulative return corresponding to the target virtual object within a target time period after start of the target gaming is less than a threshold, wherein, the cumulative return may be counted based on the gaming data in the target gaming; if the cumulative return within the target time period is less than the threshold, it indicates that the behavior type of the target virtual object determined in an initial state may not match with the operation parameters of the user, and at this time, the behavior type of the target virtual object may be further determined based on the gaming data in the target gaming, so as to adjust the behavior type of the target virtual object. Wherein, a mode of determining the behavior type of the target virtual object based on the gaming data in the target gaming is similar to the mode of determining the behavior type of the target virtual object based on the historical gaming data as described above, and no details will be repeated here.

In this embodiment, the behavior type of the target virtual object may be determined, and further the decision style type corresponding to the target virtual object may be determined, to determine the target reward weight parameter corresponding to the target virtual object, so as to ensure compatibility with a control behavior of the user; in addition, an output of the target virtual object may be adaptively updated based on the operation parameter of the user during the process of controlling the target virtual object for gaming, to match with the operation parameter of the user and enhance gaming experience of the user.

Step 43: sampling the interaction between the target virtual object and the interactive virtual object in the virtual environment, to obtain the target state feature. Implementation of the step is similar to the mode of obtaining the first state feature as described above, and no details will be repeated here.

Step 44: determining a target decision action of the target virtual object under the target state feature, based on the target state feature, the target reward weight parameter, and the target deep reinforcement learning model, in order to control an operation of the target virtual object based on the target decision action.

Correspondingly, the target state feature and the target reward weight parameter may be input into the target deep reinforcement learning model, to obtain the decision action output by the target deep reinforcement learning model, further control the target virtual object based on the decision action, and implement interaction with the interactive virtual object.

Therefore, through the above-described technical solutions, the decision style of the current target virtual object may be determined according to the behavior style of the interactive object during the interaction process, so that a decision style that matches with the user may be selected for interaction during interactive combat with the user, so as to enhance user interest and use experience.

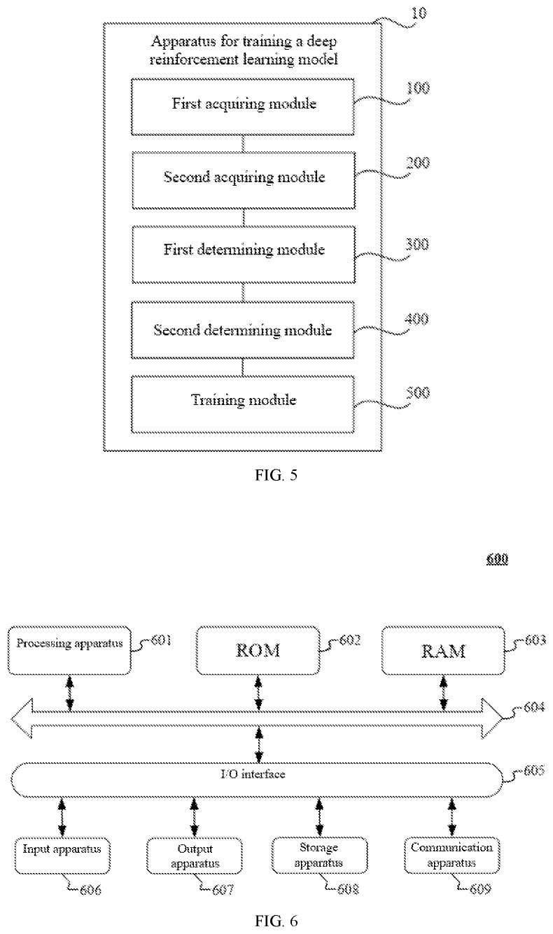

The present disclosure further provides an apparatus for training a deep reinforcement learning model, as illustrated in FIG. 5; and the apparatus 10 includes the first acquiring module 100, the second acquiring module 200, the first determining module 300, the second determining module 400, and the training module 500.

The first acquiring module 100 is configured to acquire an interaction sequence generated by interaction between a first virtual object and a second virtual object in a virtual environment. The interaction sequence includes multiple sampled data; each of the sampled data includes a return value obtained through the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model;

The second acquiring module 200 is configured to acquire a training reward weight parameter corresponding to each of the interaction sequences, the training reward weight parameter corresponds to a decision style type of the training deep reinforcement learning model;

The first determining module 300 is configured to determine a target return value corresponding to each of the sampled data, according to the training reward weight parameter corresponding to the interaction sequence and the return value in the interaction sequence;

The second determining module 400 is configured to determine a target loss of the training deep reinforcement learning model, according to an action-value predicted value determined based on a state feature and a decision action of each of the sampled data, and the target return value corresponding to the sampled data.

The training module 500 is configured to train the training deep reinforcement learning model based on the target loss.

Optionally, an output layer of the training deep reinforcement learning model includes a plurality of output forks; and the output forks are in one-to-one correspondence with the preset variety of reward weight parameters.

The training module is configured to update a parameter corresponding to the output fork corresponding to the training reward weight parameter in the training deep reinforcement learning model based on the target loss. The training reward weight parameter is one of the variety of reward weight parameters.

Optionally, the interaction sequence is generated through a generating module; and the generating module includes a first determining sub-module, a sampling sub-module, a second determining sub-module, and a sorting sub-module.

The first determining sub-module is configured to determine the training reward weight parameter of the training deep reinforcement learning model.

The sampling sub-module is configured to sample interaction between the first virtual object and the second virtual object in the virtual environment, to obtain the corresponding state feature of the first virtual object;

The second determining sub-module is configured to determine a decision action of the first virtual object under the state feature, based on the state feature, the training reward weight parameter, and the training deep reinforcement learning model, to control the operation of the first virtual object based on the decision action, and return to the step of sampling interaction between the first virtual object and the second virtual object in the virtual environment, to obtain the corresponding state feature of the first virtual object, until the end of the interaction round.

The sorting sub-module is configured to sort the sampled data acquired by sampling from the interaction round in an order of sampling time, to obtain the interaction sequence; and associate the interaction sequence with the training reward weight parameter, wherein, each of the sampled data includes the return value obtained by executing the decision action under the state feature in the virtual environment.

Optionally, the output layer of the training deep reinforcement learning model includes a plurality of output forks; and the output forks are in one-to-one correspondence with the preset variety of reward weight parameters;

The second determining sub-module includes a third determining sub-module.

The third determining sub-module is configured to input the state feature and the training reward weight parameter into the training deep reinforcement learning model, to perform feature extraction on the state feature and the training reward weight parameter through a feature layer of the training deep reinforcement learning model, obtain sub-outputs corresponding to the plurality of output forks of the output layer based on the extracted feature, and determine the decision action, according to the sub-output corresponding to the output fork corresponding to the training reward weight parameter in the training deep reinforcement learning model.

Optionally, the second determining sub-module includes a fourth determining sub-module.

The fourth determining sub-module is configured to input the state feature and the training reward weight parameter into the training deep reinforcement learning model, and determine the decision action according to the output of the training deep reinforcement learning model.

The training deep reinforcement learning model includes a neural network feature layer, a type feature layer, and an attention layer.

The neural network feature layer is used for determining a state feature vector corresponding to the state feature and a parameter feature vector corresponding to the training reward weight parameter; the type feature layer is used for determining a type feature vector corresponding to each candidate type under the type feature layer based on the state feature vector and the parameter feature vector, wherein, the candidate type is in one-to-one correspondence with a hidden-layer decision style; the attention layer is used for fusing a type feature vector corresponding to each type based on an attention mechanism according to the parameter feature vector, and determining the output of the training deep reinforcement learning model according to a fusion result.

Optionally, the first virtual object and the second virtual object have different role types; and the historical deep reinforcement learning model and the training deep reinforcement learning model respectively correspond to different training reward weight parameters;

The role type corresponding to the second virtual object and the training reward weight parameter corresponding to the historical deep reinforcement learning model are determined in a mode below:
Acquiring a training role type corresponding to the first virtual object controlled by the training deep reinforcement learning model;
Determining a first target winning probability between a virtual object corresponding to the training role type and a virtual object corresponding to each candidate role type among the preset plurality of role types except the training role type;
Determining a second target winning probability between a virtual object controlled based on a deep reinforcement learning model corresponding to a first reward weight parameter and a virtual object controlled based on a deep reinforcement learning model corresponding to a second reward weight parameter. The first reward weight parameter is the training reward weight parameter corresponding to the training deep reinforcement learning model, and the second reward weight parameter is each reward weight parameter among the preset variety of reward weight parameters except the first reward weight parameter;
Determining the role type corresponding to the second virtual object from the candidate role types, based on the training role type and the first target winning probability; and determining the training reward weight parameter corresponding to the historical deep reinforcement learning model from the second reward weight parameter, based on the training reward weight parameter corresponding to the training deep reinforcement learning model and the second target winning probability.

The present disclosure further provides an apparatus for controlling a virtual object; and the apparatus may include: a third determining module, a fourth determining module, a sampling module, and a control module.

The third determining module is configured to determine an interactive virtual object controlled by a user that matches with a target virtual object in a target gaming, wherein, the target virtual object is controlled based on a target deep reinforcement learning model; and the target deep reinforcement learning model is obtained through training based on the training method of the deep reinforcement learning model according to any one of the above;

The fourth determining module is configured to determine a target reward weight parameter of the target virtual object from a variety of reward weight parameters, according to a behavior type of the target virtual object in the target gaming. The target reward weight parameter corresponds to a decision style type of the target deep reinforcement learning model.

The sampling module is configured to sample interaction between the target virtual object and the interactive virtual object in a virtual environment, to obtain a target state feature.

The control module is configured to determine a target decision action of the target virtual object under the target state feature, based on the target state feature, the target reward weight parameter, and the target deep reinforcement learning model, to control an operation of the target virtual object based on the target decision action.

Optionally, the behavior type of the target virtual object in the target gaming is determined in a mode below:

Determining the behavior type of the target virtual object at the beginning of the target gaming, based on the historical gaming data of the interactive virtual object; and

In the process of target gaming, if a type update condition is met, determining the behavior type of the target virtual object, based on the gaming data of the interactive virtual object in the target gaming.

Referring to FIG. 6 below, FIG. 6 shows a structural schematic diagram of an electronic device 600 suitable for implementing the embodiment of the present disclosure. The terminal device according to the embodiment of the present disclosure may include, but not limited to, a mobile terminal such as a mobile phone, a laptop, a digital broadcast receiver, a Personal Digital Assistant (PDA), a Portable Android Device (PAD), a Portable Multimedia Player (PMP), a vehicle-mounted terminal (e.g., a vehicle-mounted navigation terminal), etc., and a stationary terminal such as a digital TV, a desktop computer, etc. The electronic device shown in FIG. 6 is only an example, and should not impose any limitations on the functions and scope of use of the embodiments of the present disclosure.

As illustrated in in FIG. 6, the electronic device 600 may include a processing apparatus (e.g., a central processing unit, a graphics processor, etc.) 601, which may execute various appropriate actions and processing according to a program stored in a Read-Only Memory (ROM) 602 or a program loaded from a storage apparatus 608 into a Random Access Memory (RAM) 603. The RAM 603 further stores various programs and data required for operation of the electronic device 600. The processing apparatus 601, the ROM 602, and the RAM 603 are connected with each other through a bus 604. An input/output (I/O) interface 605 is also coupled to the bus 604.

Usually, apparatuses below may be coupled to the I/O interface 605: input apparatuses 606 including, for example, a touch screen, a touch pad, a keyboard, a mouse, a camera, a microphone, an accelerometer, a gyroscope, etc.; output apparatuses 607 including, for example, a Liquid Crystal Display (LCD), a speaker, a vibrator, etc.; storage apparatuses 608 including, for example, a magnetic tape, a hard disk, etc.; and a communication apparatus 609. The communication apparatus 609 may allow the electronic device 600 to perform wireless or wired communication with other device so as to exchange data. Although FIG. 6 shows the electronic device 600 including various apparatuses, it should be understood that, it is not required to implement or have all the apparatuses shown, and the electronic device 600 may alternatively implement or have more or fewer apparatuses.

Specifically, according to the embodiments of the present disclosure, the process described above with reference to a flow chart may be implemented as computer software programs. For example, the embodiments of the present disclosure include a computer program product, including a computer program carried on a non-temporary computer-readable medium, the computer program containing program codes for executing the method shown in the flow chart. In such embodiments, the computer program may be downloaded and installed from the network via the communication apparatus 609, or installed from the storage apparatus 608, or installed from the ROM 602. When executed by the processing apparatus 601, the computer program may execute the above-described functions defined in the method according to the embodiment of the present disclosure.

It should be noted that, the above-described computer-readable medium according to the present disclosure may be a computer-readable signal medium or a computer-readable storage medium or any combination of the above two. The computer-readable storage medium may be, for example, but not limited to, an electronic, magnetic, optical, electromagnetic, infrared, or semiconductor system, apparatus, or device, or any suitable combination of the above. More specific examples of the computer-readable storage medium may include, but not limited to: an electrical connection having one or more conductors, a portable computer diskette, a hard disk, a random access memory (RAM), a Read-Only Memory (ROM); an Erasable Programmable Read-Only Memory (EPROM or Flash memory); an optical fiber, a portable Compact Disc Read-Only Memory (CD-ROM); an optical storage device; a magnetic storage device; or any suitable combination of the above. In the present disclosure, a computer-readable storage medium may be any tangible medium that contains or stores a program that may be used by or in conjunction with an instruction executing system, an apparatus, or a device. Rather, in the present disclosure, the computer-readable signal medium may include a data signal propagated in baseband or as a portion of a carrier wave, which carries a computer-readable program code therein. Such propagated data signals may take a variety of forms, including but not limited to, electromagnetic signals, optical signals, or any suitable combination of the above. The computer-readable signal medium may also be any computer-readable medium other than a computer-readable storage medium; and the computer-readable signal medium may transmit, propagate, or transport programs for use by or in combination with the instruction executing system, the apparatus, or the device. The program code embodied on the computer-readable medium may be transmitted by using any suitable medium, including, but not limited to, an electrical wire, an optical cable, a Radio Frequency (RF), etc., or any suitable combination of the above.

In some implementations, the client and the server may communicate with any network protocol currently known or to be researched and developed in the future such as HyperText Transfer Protocol (HTTP), and may communicate (e.g., via a communication network) and interconnect with digital data in any form or medium. Examples of communication networks include a Local Area Network (“LAN”), a Wide Area Network (“WAN”), the Internet, and an end-to-end network (e.g., an ad hoc end-to-end network), as well as any network currently known or to be researched and developed in the future.

The above-described computer-readable medium may be included in the above-described electronic device; or may also exist alone without being assembled into the electronic device.

The above-described computer-readable medium carries one or more programs; and when executed by the electronic device, the above-described one or more programs cause the electronic device to: acquire an interaction sequence generated by interaction between a first virtual object and a second virtual object in a virtual environment, wherein, the interaction sequence includes multiple sampled data; each of the sampled data includes a return value obtained through the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model; acquire a training reward weight parameter corresponding to each of the interaction sequences, wherein, the training reward weight parameter corresponds to a decision style type of the training deep reinforcement learning model; determine a target return value corresponding to each of the sampled data, according to the training reward weight parameter corresponding to the interaction sequence and the return value in the interaction sequence; determine a target loss of the training deep reinforcement learning model, according to an action-value predicted value determined based on a state feature and a decision action of each of the sampled data, and the target return value corresponding to the sampled data; and train the training deep reinforcement learning model based on the target loss.

Alternatively, the above-described computer-readable medium carries one or more programs; and when executed by the electronic device, the above-described one or more programs cause the electronic device to: determine an interactive virtual object controlled by a user that matches with a target virtual object in a target gaming, wherein, the target virtual object is controlled based on a target deep reinforcement learning model; and the target deep reinforcement learning model is obtained through training based on the training method of the deep reinforcement learning model according to any one of the above; determine a target reward weight parameter of the target virtual object from a variety of reward weight parameters, according to a behavior type of the target virtual object in the target gaming, wherein, the target reward weight parameter corresponds to a decision style type of the target deep reinforcement learning model; sample interaction between the target virtual object and the interactive virtual object in a virtual environment, to obtain a target state feature; and determine a target decision action of the target virtual object under the target state feature, based on the target state feature, the target reward weight parameter, and the target deep reinforcement learning model, to control an operation of the target virtual object based on the target decision action.

The computer program codes for executing the operations according to the present disclosure may be written in one or more programming languages or a combination thereof; the above-described programming languages include, but not limited to, object-oriented programming languages such as Java, Smalltalk, C++, and also include conventional procedural programming languages such as “C” language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (e.g., through the Internet using an Internet Service Provider).

The flow chart and block diagrams in the accompanying drawings illustrate the architecture, functionality, and operation of possible implementations of systems, methods, and computer program products according to various embodiments of the present disclosure. In this regard, each block in the flow chart or block diagrams may represent a module, a program segment, or a portion of codes, which comprises one or more executable instructions for implementing specified logical function(s). It should also be noted that, in some alternative implementations, the functions noted in the block may occur out of the order noted in the accompanying drawings. For example, two blocks shown in succession may, in fact, be executed substantially concurrently, or the blocks may sometimes be executed in a reverse order, depending upon the functionality involved. It should also be noted that, each block of the block diagrams and/or flow charts, and combinations of blocks in the block diagrams and/or flow charts, may be implemented by special purpose hardware-based systems that execute the specified functions or operations, or may also be implemented by a combination of special purpose hardware and computer instructions.

The modules involved in the embodiments of the present disclosure may be implemented by software or hardware. Wherein, a name of the module does not constitute limitation of the module per se in some cases, for example, the first acquiring module may also be described as “a module that acquires an interaction sequence generated by interaction between a first virtual object and a second virtual object in a virtual environment”.

The functions described herein above may be executed, at least partially, by one or more hardware logic components. For example, without limitation, available exemplary types of hardware logic components include: a Field Programmable Gate Array (FPGA), an Application Specific Integrated Circuit (ASIC), an Application Specific Standard Product (ASSP), a System on Chip (SOC), a Complex Programmable Logical Device (CPLD), etc.

In the context of the present disclosure, a machine-readable medium may be a tangible medium, which may contain or store programs for use by or in combination with an instruction executing system, an apparatus, or a device. The machine-readable medium may be a machine-readable signal medium or a machine-readable storage medium.

Machine-readable media may include, but are not limited to, electronic, magnetic, optical, electromagnetic, infrared, or semiconductor systems, apparatuses, or devices, or any suitable combination of the above contents. A more specific example of the machine-readable storage medium would include an electrical connection based on one or more lines, a portable computer disk, a hard disk, a random access memory (RAM), a Read-Only Memory (ROM), an Erasable Programmable Read-Only Memory (EPROM or a flash memory), an optical fiber, a Portable Compact Disk Read-Only Memory (CD-ROM), an optical storage device, a magnetic storage device, or any suitable combination of the above contents.

According to one or more embodiments of the present disclosure, Example 1 provides a training method of a deep reinforcement learning model, the method including: acquiring an interaction sequence generated by interaction between a first virtual object and a second virtual object in a virtual environment, wherein the interaction sequence includes multiple sampled data; each of the sampled data includes a return value obtained through the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model; acquiring a training reward weight parameter corresponding to each of the interaction sequences, wherein the training reward weight parameter corresponds to a decision style type of the training deep reinforcement learning model; determining a target return value corresponding to each of the sampled data, according to the training reward weight parameter corresponding to the interaction sequence and the return value in the interaction sequence; determining a target loss of the training deep reinforcement learning model, according to an action-value predicted value determined based on a state feature and a decision action of each of the sampled data, and the target return value corresponding to the sampled data; and training the training deep reinforcement learning model based on the target loss.

According to one or more embodiments of the present disclosure, Example 2 provides the method according to Example 1, wherein an output layer of the training deep reinforcement learning model includes a plurality of output forks; the output forks are in one-to-one correspondence with the preset variety of reward weight parameters; and the training the training deep reinforcement learning model based on the target loss, includes: updating a parameter corresponding to the output fork corresponding to the training reward weight parameter in the training deep reinforcement learning model based on the target loss, the training reward weight parameter being one of the variety of reward weight parameters.

According to one or more embodiments of the present disclosure, Example 3 provides the method according to Example 1, wherein the interaction sequence is generated in a mode below: determining the training reward weight parameter of the training deep reinforcement learning model; sampling interaction between the first virtual object and the second virtual object in the virtual environment, to obtain the corresponding state feature of the first virtual object; determining a decision action of the first virtual object under the state feature, based on the state feature, the training reward weight parameter, and the training deep reinforcement learning model, to control the operation of the first virtual object based on the decision action, and returning to the step of sampling interaction between the first virtual object and the second virtual object in the virtual environment, to obtain the corresponding state feature of the first virtual object, until the end of the interaction round; sorting the sampled data acquired by sampling from the interaction round in an order of sampling time, to obtain the interaction sequence; and associating the interaction sequence with the training reward weight parameter, wherein each of the sampled data includes the return value obtained by executing the decision action under the state feature in the virtual environment.

According to one or more embodiments of the present disclosure, Example 4 provides the method according to Example 3, wherein the output layer of the training deep reinforcement learning model includes a plurality of output forks; the output forks are in one-to-one correspondence with the preset variety of reward weight parameters; and the determining a decision action of the first virtual object under the state feature, based on the state feature, the training reward weight parameter, and the training deep reinforcement learning model, includes: inputting the state feature and the training reward weight parameter into the training deep reinforcement learning model, to perform feature extraction on the state feature and the training reward weight parameter through a feature layer of the training deep reinforcement learning model, obtaining sub-outputs corresponding to the plurality of output forks of the output layer based on the extracted feature, and determining the decision action, according to the sub-output corresponding to the output fork corresponding to the training reward weight parameter in the training deep reinforcement learning model.

According to one or more embodiments of the present disclosure, Example 5 provides the method according to Example 3, wherein the determining a decision action of the first virtual object under the state feature, based on the state feature, the training reward weight parameter, and the training deep reinforcement learning model, includes: inputting the state feature and the training reward weight parameter into the training deep reinforcement learning model, and determining the decision action according to the output of the training deep reinforcement learning model; wherein, the training deep reinforcement learning model includes a neural network feature layer, a type feature layer, and an attention layer; the neural network feature layer is used for determining a state feature vector corresponding to the state feature and a parameter feature vector corresponding to the training reward weight parameter; the type feature layer is used for determining a type feature vector corresponding to each candidate type under the type feature layer based on the state feature vector and the parameter feature vector, wherein, the candidate type is in one-to-one correspondence with a hidden-layer decision style; the attention layer is used for fusing a type feature vector corresponding to each type based on an attention mechanism according to the parameter feature vector, and determining the output of the training deep reinforcement learning model according to a fusion result.

According to one or more embodiments of the present disclosure, Example 6 provides the method according to Example 1, wherein the first virtual object and the second virtual object have different role types; the historical deep reinforcement learning model and the training deep reinforcement learning model respectively correspond to different training reward weight parameters; and the role type corresponding to the second virtual object and the training reward weight parameter corresponding to the historical deep reinforcement learning model are determined in a mode below: acquiring a training role type corresponding to the first virtual object controlled by the training deep reinforcement learning model; determining a first target winning probability between a virtual object corresponding to the training role type and a virtual object corresponding to each candidate role type among the preset plurality of role types except the training role type; determining a second target winning probability between a virtual object controlled based on a deep reinforcement learning model corresponding to a first reward weight parameter and a virtual object controlled based on a deep reinforcement learning model corresponding to a second reward weight parameter, wherein, the first reward weight parameter is the training reward weight parameter corresponding to the training deep reinforcement learning model, and the second reward weight parameter is each reward weight parameter among the preset variety of reward weight parameters except the first reward weight parameter; determining the role type corresponding to the second virtual object from the candidate role types, based on the training role type and the first target winning probability; and determining the training reward weight parameter corresponding to the historical deep reinforcement learning model from the second reward weight parameter, based on the training reward weight parameter corresponding to the training deep reinforcement learning model and the second target winning probability.

According to one or more embodiments of the present disclosure, Example 7 provides a control method of a virtual object, the method including: determining an interactive virtual object controlled by a user that matches with a target virtual object in a target gaming, wherein, the target virtual object is controlled based on a target deep reinforcement learning model; and the target deep reinforcement learning model is obtained through training based on the training method of the deep reinforcement learning model according to any one of Examples 1 to 6; determining a target reward weight parameter of the target virtual object from a variety of reward weight parameters, according to a behavior type of the target virtual object in the target gaming, wherein, the target reward weight parameter corresponds to a decision style type of the target deep reinforcement learning model; sampling interaction between the target virtual object and the interactive virtual object in a virtual environment, to obtain a target state feature; and determining a target decision action of the target virtual object under the target state feature, based on the target state feature, the target reward weight parameter, and the target deep reinforcement learning model, to control an operation of the target virtual object based on the target decision action.

According to one or more embodiments of the present disclosure, Example 8 provides the method according to Example 7, wherein the behavior type of the target virtual object in the target gaming is determined in a mode below: determining the behavior type of the target virtual object at the beginning of the target gaming, based on the historical gaming data of the interactive virtual object; and in the process of target gaming, if a type update condition is met, determining the behavior type of the target virtual object, based on the gaming data of the interactive virtual object in the target gaming.

According to one or more embodiments of the present disclosure, Example 9 provides an apparatus for training a deep reinforcement learning model, the apparatus including: a first acquiring module, a second acquiring module, a first determining module, a second determining module, and a training module. The first acquiring module is configured to acquire an interaction sequence generated by interaction between a first virtual object and a second virtual object in a virtual environment. The interaction sequence includes multiple sampled data; each of the sampled data includes a return value obtained through the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model; the second acquiring module is configured to acquire a training reward weight parameter corresponding to each of the interaction sequences, the training reward weight parameter corresponds to a decision style type of the training deep reinforcement learning model; the first determining module is configured to determine a target return value corresponding to each of the sampled data, according to the training reward weight parameter corresponding to the interaction sequence and the return value in the interaction sequence; the second determining module is configured to determine a target loss of the training deep reinforcement learning model, according to an action-value predicted value determined based on a state feature and a decision action of each of the sampled data, and the target return value corresponding to the sampled data; and the training module is configured to train the training deep reinforcement learning model based on the target loss.

According to one or more embodiments of the present disclosure, Example 10 provides an apparatus for controlling a virtual object, the apparatus including a third determining module, a fourth determining module, a sampling module, and a control module. The third determining module is configured to determine an interactive virtual object controlled by a user that matches with a target virtual object in a target gaming, the target virtual object is controlled based on a target deep reinforcement learning model, and the target deep reinforcement learning model is obtained through training based on the training method of the deep reinforcement learning model according to any one of Examples 1 to 6. The fourth determining module is configured to determine a target reward weight parameter of the target virtual object from a variety of reward weight parameters, according to a behavior type of the target virtual object in the target gaming. The target reward weight parameter corresponds to a decision style type of the target deep reinforcement learning model. The sampling module is configured to sample interaction between the target virtual object and the interactive virtual object in a virtual environment, to obtain a target state feature. The control module is configured to determine a target decision action of the target virtual object under the target state feature, based on the target state feature, the target reward weight parameter, and the target deep reinforcement learning model, to control an operation of the target virtual object based on the target decision action.

According to one or more embodiments of the present disclosure, Example 11 provides a computer-readable medium, having a computer program stored thereon. When executed by a processing apparatus, the program implements the steps of the method according to any one of Examples 1 to 8.

According to one or more embodiments of the present disclosure, Example 12 provides an electronic device, including a storage apparatus and a processing apparatus.

The storage apparatus has a computer program stored thereon; and the processing apparatus is configured to execute the computer program in the storage apparatus, to implement the steps of the method according to any one of Examples 1 to 8.

The above description is only preferred embodiments of the present disclosure and explanation of the applied technical principles. Those skilled in the art should understand that the scope of disclosure involved in the present disclosure is not only limited to the technical solutions formed by the specific combination of the above-described technical features, but also covers other technical solutions formed by an arbitrary combination of the above-described technical features or equivalent features thereof without departing from the above-described disclosure concept. For example, the above-described features and the technical features disclosed in the present disclosure (but not limited thereto) and having similar functions are replaced with each other to form a technical solution.

Furthermore, although the respective operations are described in a particular order, this should not be understood as requiring the operations to be executed in the particular order shown or in a sequential order. Under certain circumstances, multitasking and parallel processing may be favorable. Similarly, although the above discussion contains a number of specific implementation details, these should not be interpreted as limiting the scope of the present disclosure. Certain features as described in the context of separate embodiments may also be implemented in a single embodiment in combination. Conversely, various features as described in the context of a single embodiment may also be implemented in a plurality of embodiments individually or in any suitable sub-combination.

Although the subject matter has been described in terms specific to the structural features and/or method logic actions, it should be understood that the subject matter defined in the appended claims is not necessarily limited to the specific features or actions as described above. On the contrary, the specific features and actions as described above are only examples of implementing the claims. With respect to the apparatus according to the above-described embodiments, the specific modes in which the respective modules execute operations have been described in detail in the embodiments related to the method, and no details will be repeated here.

1. A method for training a deep reinforcement learning model, comprising:
acquiring an interaction sequence generated by an interaction between a first virtual object and a second virtual object in a virtual environment, wherein the interaction sequence comprises multiple sampled data; each of the sampled data comprises a return value obtained by the first virtual object executing a decision action under a state feature sampled in the virtual environment, the first virtual object is controlled based on a training deep reinforcement learning model, and the second virtual object is controlled based on a historical deep reinforcement learning model corresponding to the training deep reinforcement learning model;
acquiring a training reward weight parameter corresponding to each interaction sequence, wherein the training reward weight parameter corresponds to a decision style type of the training deep reinforcement learning model;
determining a target return value corresponding to each of the sampled data, according to the training reward weight parameter corresponding to the interaction sequence and the return value in the interaction sequence;
determining a target loss of the training deep reinforcement learning model, according to an action-value predicted value determined based on a state feature and a decision action of each of the sampled data and the target return value corresponding to the sampled data; and
training the training deep reinforcement learning model based on the target loss.

2. The method according to claim 1, wherein an output layer of the training deep reinforcement learning model comprises a plurality of output forks, and the plurality of output forks are in one-to-one correspondence with a plurality of reward weight parameters which are preset; and
the training the training deep reinforcement learning model based on the target loss, comprises:
updating a parameter corresponding to an output fork corresponding to the training reward weight parameter in the training deep reinforcement learning model based on the target loss, wherein the training reward weight parameter is one of the plurality of reward weight parameters.

3. The method according to claim 1, wherein the interaction sequence is generated by:
determining the training reward weight parameter for the training deep reinforcement learning model;
sampling the interaction between the first virtual object and the second virtual object in the virtual environment, in order to obtain a state feature corresponding to the first virtual object;
determining a decision action for the first virtual object under the state feature, based on the state feature, the training reward weight parameter, and the training deep reinforcement learning model, in order to control an operation of the first virtual object based on the decision action, and returning to the step of sampling interaction between the first virtual object and the second virtual object in the virtual environment in order to obtain the state feature corresponding to the first virtual object, until an end of an interaction round; and
sorting the sampled data acquired by sampling from the interaction round in an order of sampling time, in order to obtain the interaction sequence; and associating the interaction sequence with the training reward weight parameter, wherein each of the sampled data comprises the return value obtained by executing the decision action under the state feature in the virtual environment.

4. The method according to claim 3, wherein the output layer of the training deep reinforcement learning model comprises a plurality of output forks; and the plurality of output forks are in one-to-one correspondence with a plurality of reward weight parameters which are preset;
the determining a decision action of the first virtual object under the state feature, based on the state feature, the training reward weight parameter, and the training deep reinforcement learning model, comprises:
inputting the state feature and the training reward weight parameter into the training deep reinforcement learning model, in order to perform a feature extraction on the state feature and the training reward weight parameter by a feature layer of the training deep reinforcement learning model, obtaining sub-outputs corresponding to the plurality of output forks of the output layer based on an extracted feature, and determining the decision action according to the sub-output corresponding to the output fork corresponding to the training reward weight parameter in the training deep reinforcement learning model.

5. The method according to claim 3, wherein the determining a decision action for the first virtual object under the state feature, based on the state feature, the training reward weight parameter, and the training deep reinforcement learning model, comprises:
inputting the state feature and the training reward weight parameter into the training deep reinforcement learning model, and determining the decision action according to the output of the training deep reinforcement learning model;
wherein the training deep reinforcement learning model comprises a neural network feature layer, a type feature layer, and an attention layer; and
the neural network feature layer is used for determining a state feature vector corresponding to the state feature and a parameter feature vector corresponding to the training reward weight parameter; the type feature layer is used for determining a type feature vector corresponding to each candidate type under the type feature layer based on the state feature vector and the parameter feature vector; wherein the candidate type is in one-to-one correspondence with a hidden-layer decision style; the attention layer is used for fusing a type feature vector corresponding to each type based on an attention mechanism according to the parameter feature vector, and determining the output of the training deep reinforcement learning model according to a result of the fusing.

6. The method according to claim 1, wherein the first virtual object and the second virtual object have different role types; and the historical deep reinforcement learning model and the training deep reinforcement learning model respectively correspond to different training reward weight parameters;
the role type corresponding to the second virtual object and the training reward weight parameter corresponding to the historical deep reinforcement learning model are determined by:
acquiring a training role type corresponding to the first virtual object controlled by the training deep reinforcement learning model;
determining a first target winning probability between a virtual object corresponding to the training role type and a virtual object corresponding to each candidate role type among the preset plurality of role types except the training role type;
determining a second target winning probability between a virtual object controlled based on a deep reinforcement learning model corresponding to a first reward weight parameter and a virtual object controlled based on a deep reinforcement learning model corresponding to a second reward weight parameter, wherein the first reward weight parameter is the training reward weight parameter corresponding to the training deep reinforcement learning model, and the second reward weight parameter is each reward weight parameter among the preset variety of reward weight parameters except the first reward weight parameter; and
determining the role type corresponding to the second virtual object from the candidate role types, based on the training role type and the first target winning probability; and determining the training reward weight parameter corresponding to the historical deep reinforcement learning model from the second reward weight parameter, based on the training reward weight parameter corresponding to the training deep reinforcement learning model and the second target winning probability.

7. A method for controlling a virtual object, comprising:
determining an interactive virtual object controlled by a user that matches with a target virtual object in a target gaming, wherein the target virtual object is controlled based on a target deep reinforcement learning model; and the target deep reinforcement learning model is obtained by training based on the method for training a deep reinforcement learning model according to claim 1;
determining a target reward weight parameter of the target virtual object from a plurality of reward weight parameters, according to a behavior type of the target virtual object in the target gaming, wherein the target reward weight parameter corresponds to a decision style type of the target deep reinforcement learning model;
sampling an interaction between the target virtual object and the interactive virtual object in a virtual environment, in order to obtain a target state feature; and
determining a target decision action for the target virtual object under the target state feature, based on the target state feature, the target reward weight parameter, and the target deep reinforcement learning model, in order to control an operation of the target virtual object based on the target decision action.

8. The method according to claim 7, wherein the behavior type of the target virtual object in the target gaming is determined by:
determining the behavior type of the target virtual object at the beginning of the target gaming, based on historical gaming data of the interactive virtual object; and
in the process of target gaming, determining the behavior type of the target virtual object based on gaming data of the interactive virtual object in the target gaming, in response to a type updating condition being met.

9. An apparatus for training a deep reinforcement learning model, comprising:
a first acquiring module, configured to acquire an interaction sequence generated by an interaction between a first virtual object and a second virtual object in a virtual environment, wherein the interaction sequence comprises multiple sampled data; each of the sampled data comprises a return value obtained by the first virtual object executing a decision action under a state feature sampled in the virtual environment; the first virtual object is controlled based on a training deep reinforcement learning model; and the second virtual object is controlled based on a historical deep reinforcement learning model corresponding to the training deep reinforcement learning model;
a second acquiring module, configured to acquire a training reward weight parameter corresponding to each interaction sequence, wherein the training reward weight parameter corresponds to a decision style type of the training deep reinforcement learning model;
a first determining module, configured to determine a target return value corresponding to each of the sampled data, according to the training reward weight parameter corresponding to the interaction sequence and the return value in the interaction sequence;
a second determining module, configured to determine a target loss of the training deep reinforcement learning model, according to an action-value predicted value determined based on a state feature and a decision action of each of the sampled data and the target return value corresponding to the sampled data; and
a training module, configured to train the training deep reinforcement learning model based on the target loss.

10. The apparatus according to claim 9, wherein an output layer of the training deep reinforcement learning model comprises a plurality of output forks, and the plurality of output forks are in one-to-one correspondence with a plurality of reward weight parameters which are preset; and
the training module is also configured to update a parameter corresponding to an output fork corresponding to the training reward weight parameter in the training deep reinforcement learning model based on the target loss, wherein the training reward weight parameter is one of the plurality of reward weight parameters.

11. The apparatus according to claim 9, wherein the interaction sequence is generated by:
determining the training reward weight parameter for the training deep reinforcement learning model;
sampling the interaction between the first virtual object and the second virtual object in the virtual environment, in order to obtain a state feature corresponding to the first virtual object;
determining a decision action for the first virtual object under the state feature, based on the state feature, the training reward weight parameter, and the training deep reinforcement learning model, in order to control an operation of the first virtual object based on the decision action, and returning to the step of sampling interaction between the first virtual object and the second virtual object in the virtual environment in order to obtain the state feature corresponding to the first virtual object, until an end of an interaction round; and
sorting the sampled data acquired by sampling from the interaction round in an order of sampling time, in order to obtain the interaction sequence; and associating the interaction sequence with the training reward weight parameter, wherein each of the sampled data comprises the return value obtained by executing the decision action under the state feature in the virtual environment.

12. The apparatus according to claim 11, wherein the output layer of the training deep reinforcement learning model comprises a plurality of output forks; and the plurality of output forks are in one-to-one correspondence with a plurality of reward weight parameters which are preset;
the determining a decision action of the first virtual object under the state feature, based on the state feature, the training reward weight parameter, and the training deep reinforcement learning model, comprises:
inputting the state feature and the training reward weight parameter into the training deep reinforcement learning model, in order to perform a feature extraction on the state feature and the training reward weight parameter by a feature layer of the training deep reinforcement learning model, obtaining sub-outputs corresponding to the plurality of output forks of the output layer based on an extracted feature, and determining the decision action according to the sub-output corresponding to the output fork corresponding to the training reward weight parameter in the training deep reinforcement learning model.

13. The apparatus according to claim 11, wherein the determining a decision action for the first virtual object under the state feature, based on the state feature, the training reward weight parameter, and the training deep reinforcement learning model, comprises:
inputting the state feature and the training reward weight parameter into the training deep reinforcement learning model, and determining the decision action according to the output of the training deep reinforcement learning model;
wherein the training deep reinforcement learning model comprises a neural network feature layer, a type feature layer, and an attention layer; and
the neural network feature layer is used for determining a state feature vector corresponding to the state feature and a parameter feature vector corresponding to the training reward weight parameter; the type feature layer is used for determining a type feature vector corresponding to each candidate type under the type feature layer based on the state feature vector and the parameter feature vector; wherein the candidate type is in one-to-one correspondence with a hidden-layer decision style; the attention layer is used for fusing a type feature vector corresponding to each type based on an attention mechanism according to the parameter feature vector, and determining the output of the training deep reinforcement learning model according to a result of the fusing.

14. The apparatus according to claim 9, wherein the first virtual object and the second virtual object have different role types; and the historical deep reinforcement learning model and the training deep reinforcement learning model respectively correspond to different training reward weight parameters;
the role type corresponding to the second virtual object and the training reward weight parameter corresponding to the historical deep reinforcement learning model are determined by:
acquiring a training role type corresponding to the first virtual object controlled by the training deep reinforcement learning model;
determining a first target winning probability between a virtual object corresponding to the training role type and a virtual object corresponding to each candidate role type among the preset plurality of role types except the training role type;
determining a second target winning probability between a virtual object controlled based on a deep reinforcement learning model corresponding to a first reward weight parameter and a virtual object controlled based on a deep reinforcement learning model corresponding to a second reward weight parameter, wherein the first reward weight parameter is the training reward weight parameter corresponding to the training deep reinforcement learning model, and the second reward weight parameter is each reward weight parameter among the preset variety of reward weight parameters except the first reward weight parameter; and
determining the role type corresponding to the second virtual object from the candidate role types, based on the training role type and the first target winning probability; and
determining the training reward weight parameter corresponding to the historical deep reinforcement learning model from the second reward weight parameter, based on the training reward weight parameter corresponding to the training deep reinforcement learning model and the second target winning probability.

15. An apparatus for controlling a virtual object, comprising:
a third determining module, configured to determine an interactive virtual object controlled by a user that matches with a target virtual object in a target gaming, wherein, the target virtual object is controlled based on a target deep reinforcement learning model; and
the target deep reinforcement learning model is obtained by training based on the method for training a deep reinforcement learning model according to claim 1;
a fourth determining module, configured to determine a target reward weight parameter of the target virtual object from a plurality of reward weight parameters, according to a behavior type of the target virtual object in the target gaming, wherein, the target reward weight parameter corresponds to a decision style type of the target deep reinforcement learning model;
a sampling module, configured to sample an interaction between the target virtual object and the interactive virtual object in a virtual environment, in order to obtain a target state feature; and
a control module, configured to determine a target decision action for the target virtual object under the target state feature, based on the target state feature, the target reward weight parameter, and the target deep reinforcement learning model, in order to control an operation of the target virtual object based on the target decision action.

16. A computer-readable medium, having a computer program stored thereon, wherein when executed by a processing apparatus, the computer program causes the processing apparatus to:
acquire an interaction sequence generated by an interaction between a first virtual object and a second virtual object in a virtual environment, wherein the interaction sequence comprises multiple sampled data; each of the sampled data comprises a return value obtained by the first virtual object executing a decision action under a state feature sampled in the virtual environment, the first virtual object is controlled based on a training deep reinforcement learning model, and the second virtual object is controlled based on a historical deep reinforcement learning model corresponding to the training deep reinforcement learning model;
acquire a training reward weight parameter corresponding to each interaction sequence, wherein the training reward weight parameter corresponds to a decision style type of the training deep reinforcement learning model;
determine a target return value corresponding to each of the sampled data, according to the training reward weight parameter corresponding to the interaction sequence and the return value in the interaction sequence;
determine a target loss of the training deep reinforcement learning model, according to an action-value predicted value determined based on a state feature and a decision action of each of the sampled data and the target return value corresponding to the sampled data; and
train the training deep reinforcement learning model based on the target loss.

17. The computer-readable medium according to claim 16, wherein an output layer of the training deep reinforcement learning model comprises a plurality of output forks, and the plurality of output forks are in one-to-one correspondence with a plurality of reward weight parameters which are preset; and
the training the training deep reinforcement learning model based on the target loss, comprises:
updating a parameter corresponding to an output fork corresponding to the training reward weight parameter in the training deep reinforcement learning model based on the target loss, wherein the training reward weight parameter is one of the plurality of reward weight parameters.

18. The computer-readable medium according to claim 16, wherein the interaction sequence is generated by:
determining the training reward weight parameter for the training deep reinforcement learning model;
sampling the interaction between the first virtual object and the second virtual object in the virtual environment, in order to obtain a state feature corresponding to the first virtual object;
determining a decision action for the first virtual object under the state feature, based on the state feature, the training reward weight parameter, and the training deep reinforcement learning model, in order to control an operation of the first virtual object based on the decision action, and returning to the step of sampling interaction between the first virtual object and the second virtual object in the virtual environment in order to obtain the state feature corresponding to the first virtual object, until an end of an interaction round; and
sorting the sampled data acquired by sampling from the interaction round in an order of sampling time, in order to obtain the interaction sequence; and associating the interaction sequence with the training reward weight parameter, wherein each of the sampled data comprises the return value obtained by executing the decision action under the state feature in the virtual environment.

19. The computer-readable medium according to claim 18, wherein the output layer of the training deep reinforcement learning model comprises a plurality of output forks; and the plurality of output forks are in one-to-one correspondence with a plurality of reward weight parameters which are preset;
the determining a decision action of the first virtual object under the state feature, based on the state feature, the training reward weight parameter, and the training deep reinforcement learning model, comprises:
inputting the state feature and the training reward weight parameter into the training deep reinforcement learning model, in order to perform a feature extraction on the state feature and the training reward weight parameter by a feature layer of the training deep reinforcement learning model, obtaining sub-outputs corresponding to the plurality of output forks of the output layer based on an extracted feature, and determining the decision action according to the sub-output corresponding to the output fork corresponding to the training reward weight parameter in the training deep reinforcement learning model.

20. An electronic device, comprising:
a storage apparatus, having a computer program stored thereon; and
a processing apparatus, configured to execute the computer program in the storage apparatus, and to implement the method according to claim 1.
